(19) United States
(12) Patent Application Publication
(10) Pub. No.: US 2009/0256008 A1
(43) Pub. Date: Oct. 15, 2009

(54) Trigger Sprayer Nozzle Assembly with Pull/Push Foaming Tube

(75) Inventors: Donald D. Foster, St. Charles, MO (US); Philip L. Nelson, Wildwood, MO (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: CONTINENTALAFA DISPENSING COMPANY, St. Peters, MO (US)

(21) Appl. No.: 12/101,593

(22) Filed: Apr. 11, 2008

(51) Int. Cl. B05B 1/12; B05B 9/043

(52) U.S. Cl. 239/539; 239/589; 239/333

(57) ABSTRACT

An indexing nozzle assembly for a trigger sprayer is comprised of a nozzle base that is attachable to a sprayer housing of the trigger sprayer, a cap that is mounted for rotation on the nozzle base, and a foaming tube that is mounted for linear reciprocating movement on the cap. Rotation of the cap on the nozzle base changes liquid discharge from the trigger sprayer between an off condition and at least a spray condition. In the spray condition of the nozzle cap, the foaming tube can be manually pulled and extended from the nozzle cap. With the foaming tube extended from the nozzle cap, the liquid discharge from the nozzle assembly in a spray pattern comes into contact with an interior surface of the tube and generates a foam discharge from the nozzle assembly.

### BACKGROUND OF THE INVENTION

1. Field of the Invention

The present invention pertains to a handheld and hand operated liquid sprayer commonly called a trigger sprayer. In particular, the present invention pertains to an indexing nozzle assembly for a trigger sprayer that is comprised of a nozzle base that is attachable to a sprayer housing of the trigger sprayer, a cap that is mounted for rotation on the nozzle base, and a foaming tube that is mounted for linear reciprocating movement on the cap. With the nozzle base attached to the trigger sprayer housing, liquid discharged from the housing passes through the nozzle base. The rotation of the cap on the nozzle base changes the nozzle assembly between an off condition and a spray condition. In the spray condition of the nozzle cap, the foaming tube can be manually pulled and extended from the nozzle cap. With the foaming tube extended from the nozzle cap, liquid discharged from the nozzle assembly in a spray pattern comes into contact with an interior surface of the tube and generates a foam discharge from the nozzle assembly.

2. Description of the Related Art

Handheld and hand operated liquid sprayers commonly known as trigger sprayers are well known in the liquid sprayer art. Trigger sprayers are commonly used to dispense cleaning liquids by manually manipulating a trigger on the trigger sprayer. The trigger sprayer is typically connected to a plastic bottle containing the liquid dispensed by the trigger sprayer. In certain types of trigger sprayers, the condition of liquid discharged by the sprayer can be changed between a spray pattern, a stream pattern, and as a foam.

A typical trigger sprayer is comprised of a sprayer housing that is connected to a neck of the liquid containing bottle. The sprayer housing either has a thread connection to the bottle, or a bayonet-type connection. The sprayer housing is formed with a pump chamber, a liquid discharge passage that extends from the pump chamber through the sprayer housing to a discharge orifice of the trigger sprayer, and a liquid supply passage that communicates the pump chamber with a dip tube that extends into the liquid of the bottle. The typical trigger sprayer housing also includes some means of venting the interior of the bottle on operation of the trigger sprayer.

A pump piston is mounted in the pump chamber for reciprocating movements of the pump piston between charge and discharge positions relative to the pump chamber. A spring is usually provided in the pump chamber for biasing the pump piston toward the charge position.

A trigger is mounted on the sprayer housing by a pivot connection at one end of the trigger. The trigger is operatively connected to the pump piston. Manually squeezing the trigger toward the sprayer housing causes the pump piston to move toward the discharge position in the pump chamber. Releasing the manual grip on the trigger allows the spring in the pump chamber to push the pump piston to the charge position, and push the trigger back to its at rest position relative to the sprayer housing.

A pair of check valves are typically assembled in the sprayer housing to control the flow of liquid through the sprayer housing. One of the check valves is provided in the liquid supply passage and controls the flow of liquid from the dip tube and through the liquid supply passage to the pump chamber, and prevents the reverse flow of liquid. The second check valve is positioned in the liquid discharge passage and controls the flow of liquid from the pump chamber through the liquid discharge passage to the discharge orifice of the trigger sprayer, and prevents the reverse flow of liquid.

A nozzle assembly containing the discharge orifice of the trigger sprayer is assembled to the sprayer housing at the outlet of the liquid discharge passage. The typical nozzle assembly includes a nozzle base that is assembled to the sprayer housing at the liquid discharge passage, and a nozzle cap that is mounted on the base. The nozzle base includes a swirl chamber that functions to impart a swirl or spin to the liquid passed through the swirl chamber on operation of the trigger sprayer. The cap is typically rotatable on the nozzle base between an off position where liquid discharge from the nozzle assembly is prevented, a spray position where the discharge of liquid from the nozzle assembly is in a spray pattern, and a stream position where the discharge of liquid is in a stream pattern. In more complex constructions of prior art nozzle assemblies, the cap is also rotatable on the nozzle assembly to a foam position where the liquid discharged through the nozzle assembly is converted to a foam.

In the operation of a typical nozzle assembly that produces a liquid discharge in a spray pattern, or a stream pattern, or a foaming discharge, the nozzle cap is rotated between four distinct positions relative to the nozzle base. The nozzle cap is rotated between an off position where the liquid discharge from the nozzle assembly is prevented, to a spray position where the liquid discharge from the nozzle assembly is in a spray pattern, to a stream position where the liquid discharge from the nozzle assembly is in a stream pattern, and to a foam position where the liquid discharge from the nozzle assembly generates a foam. Individuals using this type of prior art nozzle assembly can find them difficult to use when a particular liquid discharge pattern is desired. For example, if the individual wishes to dispense liquid from the trigger sprayer in a spray pattern, the individual must look at the nozzle assembly while rotating to the one position of the nozzle assembly relative to the sprayer housing that will allow the liquid to be discharged in a spray pattern. In a like manner, if the individual wants the liquid to be discharged as a foam, the individual must look at the nozzle cap while rotating the cap to the one position of the cap relative to the sprayer housing that the liquid discharge will be as a foam. Still further, in trigger sprayers that discharge liquid in both spray and foaming patterns, it is often necessary that the nozzle cap not only move in rotation relative to the nozzle base, but also that the nozzle cap move linearly relative to the nozzle base as the nozzle cap is rotated to and from the foam position of the nozzle cap relative to the nozzle base. This requires a more complex construction of the nozzle cap and nozzle base that can add to the manufacturing costs of the nozzle assembly and of the trigger sprayer.

It is therefore desirable to develop a more simplified construction of a nozzle assembly that is capable of producing both a spray pattern of liquid discharge from a trigger sprayer and a foaming liquid discharge from a trigger sprayer. It is also desirable that such a nozzle assembly be easier to use by the individual when switching between a spray pattern liquid discharge and a foaming liquid discharge, and vice versa.

### SUMMARY OF THE INVENTION

The trigger sprayer nozzle assembly of the present invention overcomes disadvantages associated with prior art nozzle assemblies by providing a simplified construction of a nozzle base and nozzle cap that is easy to operate by an individual to adjust the liquid discharge pattern of the nozzle assembly between an off condition and a spray liquid discharge pattern. This simplified construction of the nozzle assembly also reduces the cost of manufacturing the nozzle assembly. In addition, the nozzle assembly is provided with a foaming tube that is mounted on the nozzle cap for rotation of the tube with the nozzle cap. The foaming tube is also mounted on the nozzle cap to be manually moved in a linear manner between a non-foaming position where the tube is pushed onto the cap and does not project from the nozzle cap, and a foaming position where the tube is pulled from the nozzle cap and extends from the nozzle cap. With the tube moved to the foaming position extending from the nozzle cap, liquid discharged from the nozzle assembly in a spray pattern engages against the interior surface of the tube and generates a foam.

The nozzle assembly with the pull/push foaming tube of the invention is designed for use with substantially any type of manually operated trigger sprayer that is capable of discharging liquid in a spray pattern. In addition, the concept of the invention may be employed on nozzle assemblies that include a nozzle cap that is rotatable on a nozzle base between an off position, a spray position, and a stream position. Much of the construction of the nozzle assembly of the invention is conventional, and therefore the nozzle assembly of the invention can be employed on substantially any type of known trigger sprayer that is designed to discharge liquid in a spray pattern.

The nozzle base of the assembly has a construction that is similar to that of many conventional trigger sprayer nozzle assemblies. The base includes a liquid passage that communicates with the liquid discharge passage of the trigger sprayer housing. A swirl chamber is provided in the liquid passage. The swirl chamber receives liquid discharged through the nozzle base and imparts a swirl pattern of movement to the liquid passing through the swirl chamber.

A nozzle cap is mounted on the nozzle base for rotation of the cap relative to the base. The cap can rotate between at least an “off” position and a “spray” position relative to the base, and may also rotate to a “stream” position. The cap rotates around a rotation axis relative to the base, and is constrained against axial movement along the axis relative to the base. The nozzle cap has a liquid discharge orifice that is coaxial to the axis of rotation. In addition, the nozzle cap has liquid conducting channels formed in the nozzle cap that selectively communicate liquid from the sprayer housing liquid discharge passage with the swirl chamber of the nozzle base when the nozzle cap is rotated to the spray position of the cap relative to the base. When the nozzle cap is rotated to the closed position relative to the nozzle base, communication of liquid from the sprayer housing liquid discharge passage to the swirl chamber is blocked.

In addition to the above, the nozzle assembly of the invention includes the foamer tube that is mounted on the nozzle cap for rotation of the foamer tube with the nozzle cap. The foamer tube is also mounted to the nozzle cap for axial reciprocating movement between a retracted position and an extended position of the tube relative to the cap. In the retracted position of the tube, a cylindrical interior surface of the tube is positioned relative to the orifice of the nozzle cap where the spray pattern of liquid discharged from the orifice will bypass the tube interior surface and not come into contact with the tube interior surface. This allows the nozzle assembly to discharge liquid in a spray pattern. In the extended position of the foamer tube relative to the nozzle cap, the spray pattern of liquid discharged from the nozzle cap orifice will contact with the interior surface of the tube. The spray pattern of liquid contacting the interior surface of the tube generates a foam discharge from the tube of the nozzle sprayer assembly. With the nozzle cap in the spray position relative to the nozzle base, the foamer tube is easily manipulated between the retracted and extended positions relative to the nozzle cap by manually gripping opposite sides of the foamer tube and respectively pushing the tube toward the nozzle cap and pulling the tube from the nozzle cap.

The trigger sprayer nozzle assembly with the pull/push foaming tube described above has a more simplified construction than prior art nozzle assemblies that are selectively adjustable to provide a closed condition, and at least a spray liquid discharge and a foaming liquid discharge. In addition, the simplified construction of the nozzle assembly with the pull/push foaming tube of the invention is more easily operated by individuals than those of the prior art that provide a closed condition, and at least a spray condition and a foaming condition of liquid discharge.

### DESCRIPTION OF THE DRAWING FIGURES

Further features of the invention are set forth in the following detailed description of the preferred embodiment of the invention and in the drawing figures.

FIG. 1 is a perspective view of the trigger sprayer nozzle assembly with the pull/push foaming tube of the invention.

FIG. 2 is a front view of the nozzle assembly.

FIG. 3 is a side view of the nozzle assembly shown attached to a trigger sprayer represented in dashed lines.

FIG. 4 is a cross-section view of the nozzle assembly in the plane of line 4-4 of FIG. 2, with the pull/push foaming tube in the retracted position relative to the nozzle cap.

FIG. 5 is a cross-section view similar to that of FIG. 4, but with the pull/push foaming tube in the extended position relative to the nozzle cap.

### DETAILED DESCRIPTION OF THE PREFERRED EMBODIMENT

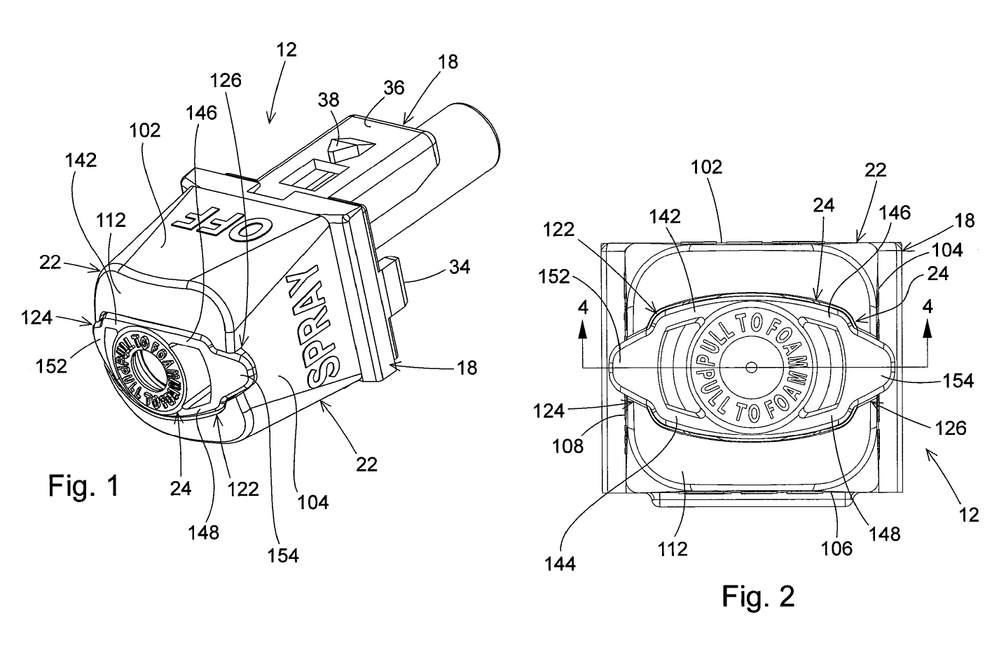

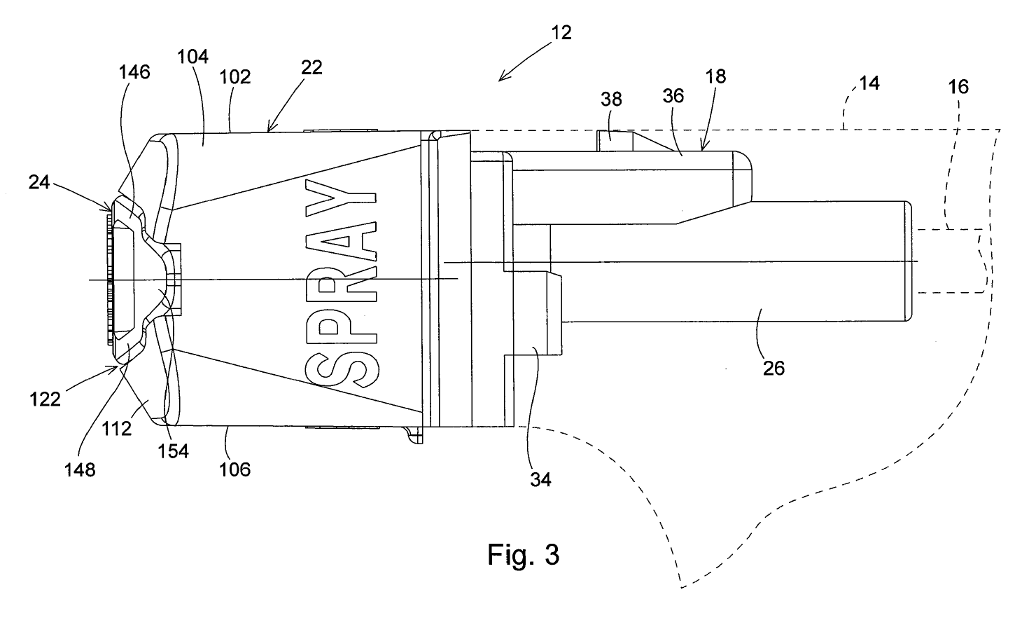

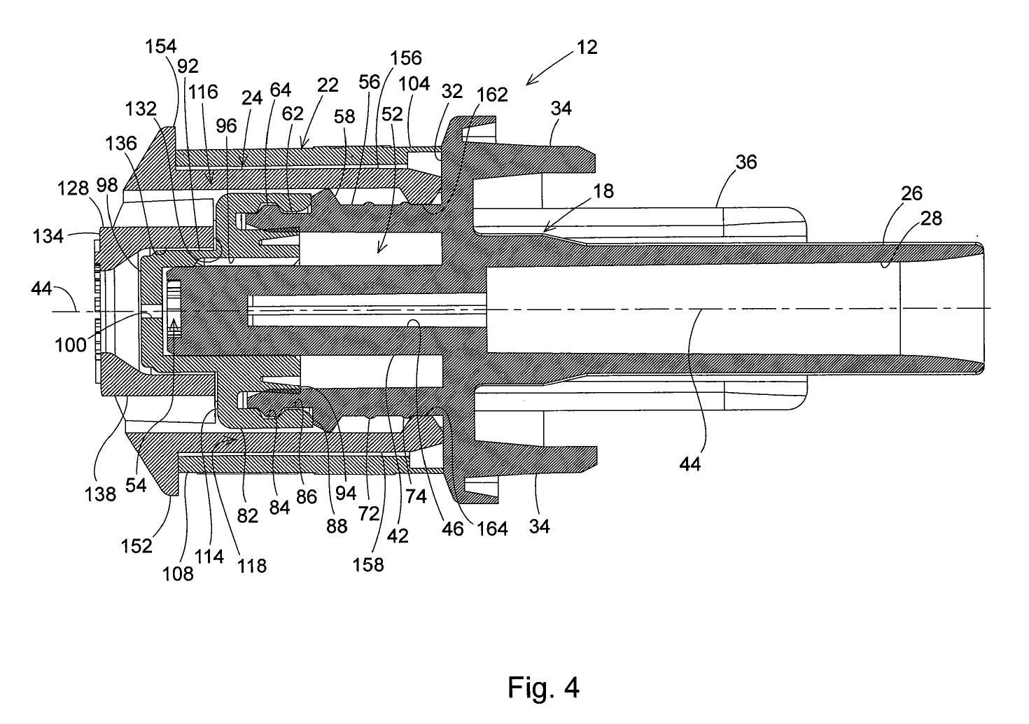

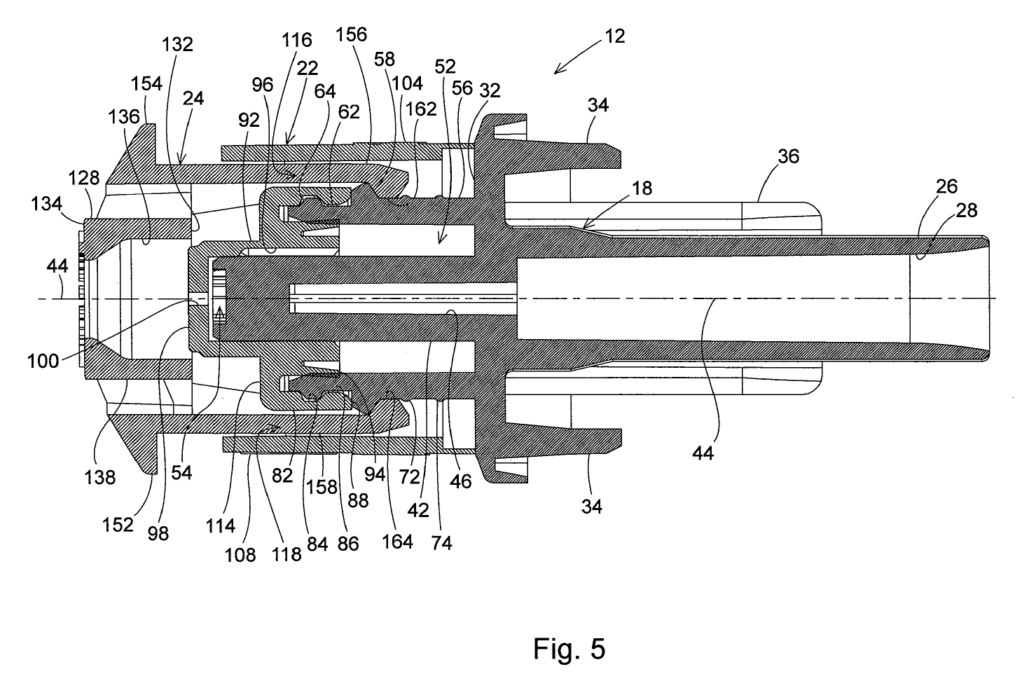

The trigger sprayer nozzle assembly of the invention is similar to, but has a more simplified construction than the nozzle assembly of the U.S. Patent of Foster et al. No. 6,557,783, which is assigned to the assignee of the present invention and is incorporated herein by reference. FIG. 1 is a perspective view of the nozzle assembly 12 of the invention removed from a trigger sprayer. FIG. 3 is a side view of the nozzle assembly 12 assembled to a trigger sprayer 14. The trigger sprayer 14 is shown in dashed lines in FIG. 2 because the nozzle assembly 12 of the invention is designed to be used with essentially any type of manually held and manually operated trigger sprayer that discharges liquid through the liquid discharge passage 16 of the sprayer. The nozzle assembly 12 is shown in FIG. 3 communicating with the liquid discharge passage 16 of the trigger sprayer 14. The nozzle assembly 12 is comprised of only three basic component parts. These include a nozzle base 18, a nozzle cap 22, and a foaming tube 24. The nozzle cap 22 is mounted on the nozzle base 18 for free rotation of the nozzle cap 22 in opposite directions on the nozzle base 18. In addition, the nozzle cap 22 can also be rotated in more than one complete rotation in either direction on the nozzle base 18. The foaming tube 24 is mounted on the nozzle cap 22 for rotation of the tube with the cap relative to the nozzle base 18. In addition, the foaming tube 24 is mounted on the nozzle cap 22 for linear reciprocating movements between a first retracted position of the tube 24 relative to the cap 22 shown in FIG. 4, and a second extended position of the tube 24 relative to the cap 22 shown in FIG. 5. The nozzle base 18, the nozzle cap 22, and the foaming tube 24 are all constructed of plastic materials that are typically employed in the construction of trigger sprayers.

FIG. 4 is a cross-section view of the nozzle assembly 12 removed from the trigger sprayer 14. The nozzle base 18 of the assembly 12 has a construction that is typical of the construction of many prior art nozzle assemblies, and therefore will only be described generally herein.

The base 18 includes a liquid passage tube 26 that is assembled over the liquid discharge passage 16 of the trigger sprayer 14. The tube 26 has an interior bore 28 that conducts liquid delivered to the nozzle assembly 12 from the trigger sprayer liquid discharge passage 16.

The base 18 also has an end wall 32 at one end of the tube 26. The end wall 32 has a pair of flanges 34 on opposite sides of the wall 32 and a projecting tab 36 with a clip 38 that extend over the liquid passage tube 26 as shown in FIG. 3. The pair of flanges 34 and the tab 36 with the clip 38 are employed in assembling the nozzle base 18 to the sprayer housing of the trigger sprayer 14 in a conventional manner known in the prior art.

A cylindrical post 42 projects from the opposite side of the end wall 32 from the liquid passage tube 26. The post 42 has a center axis 44 that defines mutually perpendicular axial and radial directions relative to the nozzle assembly 12. The post 42 also has an interior bore 46 that communicates with the interior bore 28 of the liquid passage tube 26. Although they are not shown in the drawing figures, the post 42 also has radially extending passages from the interior bore 46 of the post 42 that communicate the center bore 46 with an interior volume 52 of the nozzle assembly 12 that surrounds the exterior of the post 42. The post 42 extends from the base end wall 32 to a distal end of the post containing a liquid swirl chamber 54. The swirl chamber 54 is constructed in a conventional manner and is operable to impart a spinning rotation to liquid that is channeled into the swirl chamber 54. Although not shown in the drawing figures, axially extending channels are formed in the exterior surface of the post 42. The channels communicate the nozzle assembly interior volume 52 with the swirl chamber 54, in the conventional manner of prior art nozzle assemblies that discharge liquid in a spray pattern.

The nozzle base 18 also includes a cylindrical outer wall 56 that extends axially from the end wall 32. The cylindrical outer wall 56 is coaxial with the post 42 and surrounds the post and the interior volume 52 of the nozzle assembly 12. The exterior surface of the outer wall 56 is provided with a nozzle stop 58 that projects radially outwardly from the center wall 56. An annular sealing groove 62 and an annular sealing rim 64 are provided on the exterior surface of the outer wall 56 on one side of the nozzle stop 58. Between the nozzle stop 58 and the nozzle base end wall 32, the outer wall 56 has a pair of axially spaced annular ribs 72, 74.

The nozzle cap 22 is mounted for rotation on the cylindrical outer wall 56 of the nozzle base 18. The cap 22 has a cylindrical outer wall 82 that surrounds the nozzle base outer wall 56. An interior surface of the cap outer wall 82 is provided with a sealing groove 84 that receives the sealing rim 64 of the nozzle base 18, and also has an annular sealing rim 86 that is received in the sealing groove 62 of the nozzle base 18. The engagement of the nozzle cap rim 86 in the nozzle base sealing groove 62 and the engagement of the nozzle base rim 64 in the nozzle cap groove 84 enables the nozzle cap 22 to be rotated on the nozzle base 18 in opposite directions and for more than one complete rotation of the nozzle cap 22 on the nozzle base 18. A distal end 88 of the nozzle cap outer wall 82 engages against the nozzle stop 58 of the nozzle base 18 when assembling the nozzle cap 22 to the nozzle base 18.

The nozzle cap 22 also has a cylindrical inner wall 92 that surrounds the nozzle base post 42. The cap inner wall 92 has a resilient, annular sealing flange 94 that engages in a sliding sealing engagement with the interior of the nozzle base outer wall 56. An interior surface of the nozzle cap inner wall 92 is provided with axially extending channels 96 that direct liquid flow to the channels (not shown) on the exterior of the nozzle base post 42, as is conventional in nozzle assemblies.

A circular end wall 98 is provided at an opposite end of the nozzle cap inner wall 92 from the inner wall sealing flange 94. The end wall 98 covers over the swirl chamber 54 in the nozzle base post 42. A liquid discharge orifice 100 passes through the end wall 98. The orifice 100 is coaxial with the swirl chamber 54 and with the center axis 44 of the nozzle base post 42.

The nozzle cap 22 also includes four side walls 102, 104, 106, 108 and an end wall 112 that surround the nozzle cap cylindrical outer wall 82 and the nozzle cap cylindrical inner wall 92. The exterior surfaces of the four side walls 102, 104, 106, 108 and the end wall 112 give the exterior of the nozzle cap 22 a cubic configuration. As shown in the drawing figures, the side walls 102, 104 are provided with indicia that indicate the “OFF” and “SPRAY” positions of the nozzle cap 22 relative to the nozzle base 18, as is conventional. With the side wall 102 having the “OFF” indicia positioned at the top of the nozzle base 18, liquid discharge through the nozzle assembly 12 is prevented. With the side wall 104 having the “SPRAY” indicia positioned at the top of the nozzle base 18, the nozzle assembly 12 discharges liquid from the trigger sprayer 14 in a spray pattern from the discharge orifice 100. The interior surfaces of the four side walls 102, 104, 106, 108 are connected to the nozzle cap outer cylindrical wall 82 and the nozzle cap inner cylindrical wall 92 by a central wall 110 of the nozzle cap.

The central wall 110, together with the outer cylindrical wall 82, enclose the interior volume 52 of the nozzle assembly that conducts liquid to the swirl chamber 54 and the discharge orifice 100. Radially outside of the nozzle cap outer cylindrical wall 82, the center wall 114 has a pair of holes 116, 118 through the wall. The holes 116, 118 are employed in mounting the foaming tube 24 to the nozzle cap 22, as will be explained. A cavity 122 is formed in the center of the nozzle cap end wall 112. The cavity 122 extends across the width of the end wall 112 and forms a pair of recesses 124, 126 in the opposite side walls 104, 108 of the nozzle cap 22. The cavity 122 extends into the nozzle cap 22 from the nozzle cap end wall 112 to the center wall 114 in the interior of the nozzle cap. The center wall 114 forms the bottom of the cavity 122.

The foaming tube 24 has a center tube 128 that surrounds the nozzle cap inner cylindrical wall 92 and the nozzle cap end wall 98. The tube 128 has an axial length that extends from a proximal end 132 of the tube to a distal end 134 of the tube. An interior surface 136 of the tube 128 has a portion adjacent the tube proximal end 132 that is dimensioned to be slightly radially larger than the exterior surface of the nozzle cap inner cylindrical wall 92. As seen in the drawing figures, as the interior surface 136 extends axially from the proximal end 132 to the distal end 134 of the tube, the surface gradually begins to taper radially inwardly toward the center axis 44. The tube exterior surface 138 is substantially cylindrical for its entire length from the tube proximal end 132 to the tube distal end 134.

Referring to FIG. 2, four arms 142, 144, 146, 148 extend radially outwardly from the tube exterior surface 138. the arms 142, 144, 146, 148 extend across the cavity 122 in the nozzle cap end wall 112 toward the pair of recesses 124, 126 in the nozzle cap side walls 104, 108. A pair of finger tabs 152, 154 are provided at the distal ends of pairs of the tube arms 142, 144, 146, 148. The finger tabs 152, 154 are positioned in the recesses 124, 126 when the foaming tube 24 is moved to its retracted position relative to the nozzle base 18 shown in FIGS. 1-4. As best seen in FIG. 4, distal ends of the finger tabs 152, 154 project radially beyond the opposite side walls 104, 108 of the nozzle cap where they are easily accessible for manual movement of the foaming tube 24.

The foaming tube 24 is mounted for axial reciprocating movement on the nozzle base 18 by a pair of resilient arcuate flanges 156, 158. As seen in FIGS. 4 and 5, the pair of arcuate flanges 156, 158 extend over opposite sides of the nozzle base outer cylindrical wall 56. The flanges 156, 158 extend from the foaming tube tabs 152, 154 to distal ends of the flanges 156, 158 that have radially inwardly projecting arcuate lips 162, 164. The pair of arcuate lips 162, 164 engage in sliding engagement with the exterior surface of the nozzle base outer wall 56. The sliding engagement of the pair of arcuate lips 162, 164 mount the foaming tube 24 for axial movement relative to the nozzle cap 22 and base 18 between the retracted position of the foaming tube 24 shown in FIG. 4 where the distal ends of the arcuate flanges 156, 158 abut against the nozzle base end wall 32, to an extended position of the foaming tube 24 shown in FIG. 5 where the arcuate lips 162, 164 of the foaming tube flanges 156, 158 abut against the nozzle stop. The sliding engagement of the foaming tube arcuate lips 162, 164 on the exterior of the nozzle base outer wall 56 also allows the foaming tube 24 to rotate with the nozzle cap 22 around the nozzle base 18. It can be seen in FIG. 4 that with the foaming tube 24 in its retracted position relative to the nozzle base 18, a spray discharge from the nozzle assembly orifice 100 will pass through the tube 128 without contacting the tube interior surface 136. With the foaming tube 24 in its extended position relative to the nozzle base 18 shown in FIG. 5, the spray discharge from the orifice 100 will contact the tube interior surface 136 and generate a foam discharge from the nozzle assembly 12.

The trigger sprayer nozzle assembly 12 with the pull/push foaming tube 24 described above has a more simplified construction than prior art nozzle assemblies that are selectively adjustable to provide a closed condition, and at least a spray liquid discharge and a foaming liquid discharge. In addition, the simplified construction of the nozzle assembly 12 with the pull/push foaming tube 24 of the invention is more easily operated by individuals than prior art nozzle assemblies that provide a closed condition, and at least a spray condition and a foam condition of liquid discharge.

Although the trigger sprayer nozzle assembly of the invention has been described above by referring to a specific embodiment of the nozzle assembly, it should be understood that modifications and variations to the nozzle assembly are possible without departing from the intended scope of the following claims.

1) A manually operated foaming trigger sprayer comprising:
a sprayer housing containing a liquid pump chamber and having a liquid inlet opening and a liquid outlet opening on the sprayer housing, a liquid supply passage extending through the sprayer housing from the liquid inlet opening to the liquid pump chamber, and a liquid discharge passage extending through the sprayer housing from the liquid pump chamber to the liquid outlet opening;
a pump piston mounted in the liquid pump chamber for reciprocating movement of the pump piston between charge and discharge positions of the pump piston in the pump chamber;
a trigger mounted on the sprayer housing for movement of the trigger between charge and discharge positions of the trigger relative to the sprayer housing, the trigger being operatively connected to the pump piston for movement of the pump piston between the charge and discharge positions of the pump piston in the pump chamber in response to movement of the trigger between the respective charge and discharge positions of the trigger relative to the sprayer housing;
a nozzle cap on the sprayer housing, the nozzle cap being rotatable about an axis of rotation to a multiple of positions of the nozzle cap relative to the sprayer housing; and,
a foamer tube mounted on the nozzle cap for axial movement of the foamer tube between a first, retracted position of the foamer tube relative to the nozzle cap and an axially spaced second, extended position of the foamer tube relative to the nozzle cap, the foamer tube being axially movable between the first and second positions of the foamer tube relative to the nozzle cap independently of the nozzle cap rotation relative to the sprayer housing and independently of the nozzle cap position relative to the sprayer housing.

2) The foaming trigger sprayer of claim 1, further comprising:
the nozzle cap being rotatable on the sprayer housing in opposite first and second directions of rotation, and the nozzle cap being rotatable for more than one complete rotation in both the first and second directions of rotation.

3) The foaming trigger sprayer of claim 1, further comprising:
the nozzle cap having a liquid discharge orifice with a center axis that is coaxial with the axis of rotation, and,
the foamer tube having a cylindrical interior surface that is coaxial with the nozzle cap liquid discharge orifice axis.

4) The foaming trigger sprayer of claim 1, further comprising:
the foamer tube having a pair of finger tabs that project outwardly from the foamer tube and project outwardly from the nozzle cap on opposite sides of the nozzle cap axis of rotation.

5) The foaming trigger sprayer of claim 4, further comprising:
the nozzle cap having a pair of recesses in an exterior surface of the nozzle cap, the recesses being positioned on opposite sides of the nozzle cap axis of rotation; and,
the foamer tube tabs being positioned in the nozzle cap recesses when the foamer tube is in the first, retracted position of the foamer tube relative to the nozzle cap.

6) The foaming trigger sprayer of claim 5, further comprising:
the foamer tube tabs project outwardly from the recesses on the opposite sides of the nozzle cap.

7) The foaming trigger sprayer of claim 1, further comprising:
the nozzle cap having an exterior configuration defined by four separate side surfaces that are arranged around the nozzle cap axis of rotation, and a front surface at one axial end of the four side surfaces;
a liquid discharge orifice extends through the nozzle cap front surface;
a cavity is recessed into the nozzle cap front surface around the nozzle cap liquid discharge orifice; and,
the foamer tube is mounted in the cavity for reciprocating movement of the foamer tube into the cavity when the foamer tube is moved to the first, retracted position, and movement of the foamer tube out of the cavity when the foamer tube is moved to the second, extended position.

8) A manually operated foaming trigger sprayer comprising:
a sprayer housing containing a liquid pump chamber and having a liquid inlet opening and a liquid outlet opening on the sprayer housing, a liquid supply passage extending through the sprayer housing from the liquid inlet opening to the liquid pump chamber, and a liquid discharge passage extending through the sprayer housing from the liquid pump chamber to the liquid outlet opening;
a pump piston mounted in the liquid pump chamber for reciprocating movement of the pump piston between charge and discharge positions of the pump piston in the pump chamber;
a trigger mounted on the sprayer housing for movement of the trigger between charge and discharge positions of the trigger relative to the sprayer housing, the trigger being operatively connected to the pump piston for movement of the pump piston between the charge and discharge positions of the pump piston in the pump chamber in response to movement of the trigger between the respective charge and discharge positions of the trigger relative to the sprayer housing;
a nozzle cap on the sprayer housing, the nozzle cap being rotatable about an axis of rotation in 90 degree rotation increments to a multiple of positions of the nozzle cap relative to the sprayer housing; and,
a foamer tube mounted on the nozzle cap, the foamer tube being movable relative to the nozzle cap between a first, retracted position of the foamer tube relative to the sprayer housing and an axially spaced second, extended position of the foamer tube relative to the sprayer housing, the foamer tube being movable between the first and second positions of the foamer tube relative to the sprayer housing in every position of the multiple positions of the nozzle cap relative to the sprayer housing.

9) The foaming trigger sprayer of claim 1, further comprising:
the nozzle cap being rotatable on the sprayer housing in opposite first and second directions of rotation, and the nozzle cap being rotatable for more than one complete rotation in both the first and second directions of rotation.

10) The foaming trigger sprayer of claim 9, further comprising:
the nozzle cap having a liquid discharge orifice with a center axis that is coaxial with the axis of rotation, and,
the foamer tube having a cylindrical interior surface that is coaxial with the nozzle cap liquid discharge orifice axis.

11) The foaming trigger sprayer of claim 9, further comprising:
the foamer tube having a pair of finger tabs that project outwardly from the foamer tube and project outwardly from the nozzle cap on opposite sides of the nozzle cap axis of rotation.

12) The foaming trigger sprayer of claim 1, further comprising:
the nozzle cap having a pair of recesses in an exterior surface of the nozzle cap, the recesses being positioned on opposite sides of the nozzle cap axis of rotation; and,
the foamer tube tabs being positioned in the nozzle cap recesses when the foamer tube is in the first, retracted position of the foamer tube relative to the nozzle cap.

13) The foaming trigger sprayer of claim 1, further comprising:
the foamer tube tabs project outwardly from the recesses on the opposite sides of the nozzle cap.

14) The foaming trigger sprayer of claim 9, further comprising:
the nozzle cap having an exterior configuration defined by four separate side surfaces that are arranged around the nozzle cap axis of rotation, and a front surface at one axial end of the four side surfaces;
a liquid discharge orifice extends through the nozzle cap front surface;
a cavity is recessed into the nozzle cap front surface around the nozzle cap liquid discharge orifice; and,
the foamer tube is mounted in the cavity for reciprocating movement of the foamer tube into the cavity when the foamer tube is moved to the first, retracted position, and movement of the foamer tube out of the cavity when the foamer tube is moved to the second, extended position.

15) A manually operated foaming trigger sprayer comprising:
a sprayer housing containing a liquid pump chamber and having a liquid inlet opening and a liquid outlet opening on the sprayer housing, a liquid supply passage extending through the sprayer housing from the liquid inlet opening to the liquid pump chamber, and a liquid discharge passage extending through the sprayer housing from the liquid pump chamber to the liquid outlet opening;
a pump piston mounted in the liquid pump chamber for reciprocating movement between charge and discharge positions of the pump piston in the pump chamber;
a trigger mounted on the sprayer housing for movement of the trigger between charge and discharge positions of the trigger relative to the sprayer housing, the trigger being operatively connected to the pump piston for movement of the trigger with the pump piston between the trigger charge and discharge positions relative to the sprayer housing with the pump piston moving between the charge and discharge positions of the pump piston in the pump chamber;
a nozzle cap on the sprayer housing, the nozzle cap being rotatable about an axis of rotation relative to the sprayer housing to a multiple of positions of the nozzle cap relative to the sprayer housing; and,
a foamer tube mounted on the nozzle cap for axial movement of the foamer tube between a first, retracted position relative to the nozzle cap and a second, extended position relative to the nozzle cap that is axially spaced from the first position of the foamer tube, the foamer tube being movable from the first position to the second position of the foamer tube relative to the nozzle cap by manually pulling the foamer tube axially from the nozzle cap, and the former tube being movable from the second position to the first position of the foamer tube relative to the nozzle cap by manually pushing the foamer tube axially toward the nozzle cap.

16) The foaming trigger sprayer of claim 15, further comprising:
the nozzle cap being rotatable on the sprayer housing in opposite first and second directions of rotation, and the nozzle cap being rotatable for more than one complete rotation in both the first and second directions of rotation.

17) The foaming trigger sprayer of claim 15, further comprising:
the nozzle cap having a liquid discharge orifice with a center axis that is coaxial with the axis of rotation, and,
the foamer tube having a cylindrical interior surface that is coaxial with the nozzle cap liquid discharge orifice axis.

18) The foaming trigger sprayer of claim 15, further comprising:
the foamer tube having a pair of finger tabs that project outwardly from the foamer tube and project outwardly from the nozzle cap on opposite sides of the nozzle cap axis of rotation.

19) The foaming trigger sprayer of claim 15, further comprising:
the nozzle cap having a pair of recesses in an exterior surface of the nozzle cap, the recesses being positioned on opposite sides of the nozzle cap axis of rotation; and,
the foamer tube tabs being positioned in the nozzle cap recesses when the foamer tube is in the first, retracted position of the foamer tube relative to the nozzle cap.

20) The foaming trigger sprayer of claim 15, further comprising:
the foamer tube tabs project outwardly from the recesses on the opposite sides of the nozzle cap.

21) The foaming trigger sprayer of claim 15, further comprising:
the nozzle cap having an exterior configuration defined by four separate side surfaces that are arranged around the nozzle cap axis of rotation, and a front surface at one axial end of the four side surfaces;
a liquid discharge orifice extends through the nozzle cap front surface;
a cavity is recessed into the nozzle cap front surface around the nozzle cap liquid discharge orifice; and,
the foamer tube is mounted in the cavity for reciprocating movement of the foamer tube into the cavity when the foamer tube is moved to the first, retracted position, and movement of the foamer tube out of the cavity when the foamer tube is moved to the second, extended position.

22) A manually operated foaming trigger sprayer comprising:
a sprayer housing containing a liquid pump chamber and having a liquid inlet opening and a liquid outlet opening on the sprayer housing, a liquid supply passage extending through the sprayer housing from the liquid inlet opening to the liquid pump chamber, and a liquid discharge passage extending through the sprayer housing from the liquid pump chamber to the liquid outlet opening;
a pump piston mounted in the liquid pump chamber for reciprocating movement of the pump piston between charge and discharge positions of the pump piston in the pump chamber;
a trigger mounted on the sprayer housing for movement of the trigger between a charge and discharge position of the trigger relative to the sprayer housing, the trigger being operatively connected to the pump piston for movement of the trigger between the charge and discharge positions of the trigger relative to the sprayer housing with movement of the pump piston between the respective charge and discharge positions of the pump piston in the pump chamber;
a nozzle cap on the sprayer housing, the nozzle cap being rotatable about an axis of rotation relative to the sprayer housing; and,
a foamer tube mounted on the nozzle cap for axial movement of the foamer tube between a first, retracted position of the foamer tube relative to the nozzle cap and a second, extended position of the foamer tube relative to the nozzle cap, the second, extended position of the foamer tube being axially spaced from the first, retracted position of the foamer tube, and the foamer tube having at least one finger tab that projects outwardly from the foamer tube in a direction that is transverse to the nozzle cap axis of rotation, and that projects outwardly from a side of the nozzle cap.

23) The foaming trigger sprayer of claim 22, further comprising:
the foamer tube having a pair of finger tabs that project outwardly from opposite sides of the foamer tube in directions that are transverse to the nozzle cap axis of rotation, and that project outwardly from opposite sides of the nozzle cap.

24) The foaming trigger sprayer of claim 23, further comprising:
the nozzle cap being rotatable on the sprayer housing in opposite first and second directions of rotation, and the nozzle cap being rotatable for more than one complete rotation in both the first and second directions of rotation.

25) The foaming trigger sprayer of claim 23, further comprising:
the nozzle cap having a liquid discharge orifice with a center axis that is coaxial with the axis of rotation, and,
the foamer tube having a cylindrical interior surface that is coaxial with the nozzle cap liquid discharge orifice axis.

26) The foaming trigger sprayer of claim 23, further comprising:
the nozzle cap having a pair of recesses in an exterior surface of the nozzle cap, the recesses being positioned on opposite sides of the nozzle cap axis of rotation; and,
the foamer tube tabs being positioned in the nozzle cap recesses when the foamer tube is in the first, retracted position of the foamer tube relative to the nozzle cap.

27) The foaming trigger sprayer of claim 26, further comprising:
the foamer tube tabs project outwardly from the recesses on the opposite sides of the nozzle cap.

28) The foaming trigger sprayer of claim 23, further comprising:
the nozzle cap having an exterior configuration defined by four separate side surfaces that are arranged around the nozzle cap axis of rotation, and a front surface at one axial end of the four side surfaces;
a liquid discharge orifice extends through the nozzle cap front surface;
a cavity is recessed into the nozzle cap front surface around the nozzle cap liquid discharge orifice; and,
the foamer tube is mounted in the cavity for reciprocating movement of the foamer tube into the cavity when the foamer tube is moved to the first, retracted position, and movement of the foamer tube out of the cavity when the foamer tube is moved to the second, extended position.
